(19) United States
(12) Patent Application Publication
(10) Pub. No.: US 2026/0183669 A1
(43) Pub. Date: Jul. 2, 2026

(54) ADVERTISEMENT INFORMATION PROCESSING APPARATUS, ADVERTISEMENT INFORMATION PROCESSING METHOD, AND NON-TRANSITORY COMPUTER-READABLE MEDIUM

(71) Applicant: NEC Corporation, Tokyo (JP)

(72) Inventors: Rui KONDO, Tokyo (JP); Yoshitomo WARASHINA, Tokyo (JP); Yasuhiko YOSHIDA, Tokyo (JP); Shinnosuke NISHIMOTO, Tokyo (JP); Haruki MIZUTANI, Tokyo (JP)

(73) Assignee: NEC Corporation, Tokyo (JP)

(21) Appl. No.: 19/421,188

(22) Filed: Dec. 16, 2025

(30) Foreign Application Priority Data
Dec. 26, 2024 (JP) 2024-231227

(51) Int. Cl. A63F 13/61; G06Q 30/0242; G06Q 30/0251

(52) U.S. Cl. CPC A63F 13/61; G06Q 30/0244; G06Q 30/0269

(57) ABSTRACT

An advertisement information processing apparatus: an advertisement information acquisition unit acquires target advertisement information to specify a magnitude of a load generated in a communication apparatus that causes a display to display an image based on a virtual space, the target advertisement information being capable of specifying the magnitude of the load in a case where a target advertisement is included in the image; a capability information acquisition unit acquires necessary capability information that is information regarding the virtual space and indicates capability required for the communication apparatus; a load information generation unit generates load information indicating the magnitude of the load in a case where the target advertisement is included in the image by using the target advertisement information; and an appropriateness information generation unit generates appropriateness information indicating appropriateness of displaying the target advertisement in the virtual space by using the load information and the necessary capability information.

This application is based upon and claims the benefit of priority from Japanese patent application No. 2024-231227, filed on Dec. 26, 2024, the disclosure of which is incorporated herein its entirety by reference.

### TECHNICAL FIELD

The present invention relates to an advertisement information processing apparatus, an advertisement information processing method, and a non-transitory computer-readable medium storing a program thereof.

### BACKGROUND ART

In recent years, use of virtual spaces has been advancing. There are cases where advertisements are displayed in virtual spaces. JP 2024-143739 A describes an apparatus for improving efficiency of examination work on advertisement materials. This apparatus includes an information acquisition unit that acquires information included in advertisement materials, a determination unit that determines appropriateness/inappropriateness of information for an examination item by using a plurality of learning models each associated to a plurality of examination items for checking whether the advertisement materials are appropriate as an advertisement, and an output unit that outputs a determination result determined by the determination unit. Each learning model learns, as learning data, a determination result of a plurality of pieces of information for each examination item, and the output unit outputs the determination result for each examination item.

### SUMMARY

In a case where an advertisement is displayed in the virtual space, there is a possibility that a load on a communication apparatus that displays an image based on the virtual space increases. If this load is too large, there is a possibility that the communication apparatus cannot perform appropriate processing. Therefore, it is desirable to evaluate whether it is appropriate to display the advertisement in the virtual space from the viewpoint of the load applied to the communication apparatus.

An advertisement information processing apparatus according to one aspect of the present disclosure includes
at least one memory storing instructions; and
at least one processor configured to execute the instructions to perform operations comprising:
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image,
acquiring necessary capability information that is information regarding the virtual space and indicates capability required for the communication apparatus,
generating load information indicating the magnitude of the load in a case where the target advertisement is included in the image by using the target advertisement information, and
generating appropriateness information indicating appropriateness of displaying the target advertisement in the virtual space by using the load information and the necessary capability information.

An advertisement information processing method according to one aspect of the present disclosure includes, by a computer,
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image,
acquiring necessary capability information that is information regarding the virtual space and indicates capability required for the communication apparatus,
generating load information indicating the magnitude of the load in a case where the target advertisement is included in the image by using the target advertisement information, and
generating appropriateness information indicating appropriateness of displaying the target advertisement in the virtual space by using the load information and the necessary capability information.

A non-transitory computer-readable medium according to one aspect of the present disclosure stores a program for causing a computer to perform operations comprising
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image,
acquiring necessary capability information that is information regarding the virtual space and indicates capability required for the communication apparatus,
generating load information indicating the magnitude of the load in a case where the target advertisement is included in the image by using the target advertisement information, and
generating appropriateness information indicating appropriateness of displaying the target advertisement in the virtual space by using the load information and the necessary capability information.

According to an example of the present disclosure, it is easy to evaluate whether it is appropriate to display the advertisement in the virtual space from the viewpoint of the load applied to the communication apparatus.

### BRIEF DESCRIPTION OF THE DRAWINGS

FIG. 1 It is a diagram illustrating an example of a use environment of an advertisement information processing apparatus;

FIG. 2 It is a diagram illustrating an example of a use environment of an advertisement information processing apparatus;

FIG. 3 It is a diagram illustrating an example of a functional configuration of an advertisement information processing apparatus;

FIG. 4 It is a diagram illustrating a hardware configuration example of an advertisement information processing apparatus;

FIG. 5 It is a flowchart illustrating an example of processing performed by an advertisement information processing apparatus; and

FIG. 6 It is a flowchart illustrating an example of processing performed by an advertisement information processing apparatus.

### EXAMPLE EMBODIMENT

Hereinafter, in the present disclosure, the drawings are associated with one or more example embodiments. In all the drawings, similar components are denoted by similar reference signs, and descriptions thereof will not be repeated as appropriate.

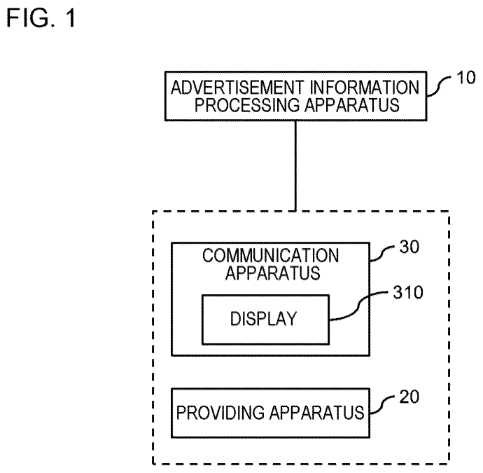

An advertisement information processing apparatus 10 is used together with a providing apparatus 20 and a communication apparatus 30 as illustrated in FIG. 1, for example. The providing apparatus 20 is an apparatus for providing a service using a virtual space to a user. The communication apparatus 30 is an apparatus operated by a user and includes a display 310. The communication apparatus 30 is, for example, a smartphone, a tablet terminal, a desktop personal computer, or a notebook personal computer. The communication apparatus 30 may include a head-mounted display type device as the display 310.

The avatar of the user is present in the virtual space provided by the providing apparatus 20. The providing apparatus 20 generates a screen to be shown to the user using at least the position of the avatar in the virtual space. This screen is associated with a scene of the virtual space obtained with reference to the current position of the avatar, for example, a scene of the virtual space as viewed from the avatar, and is displayed on the display 310 of the communication apparatus 30. In generating this screen, the providing apparatus 20 may further use at least one of the orientation of the avatar's body or face and the line of sight. At least a part of this processing may be performed by the communication apparatus 30.

The user performs an input for changing the position of the avatar by operating the communication apparatus 30. Then, the providing apparatus 20 changes the position of the avatar in accordance with the input, and changes the screen to be displayed on the display 310 in accordance with the change in the position. At least a part of this processing may be performed by the communication apparatus 30.

An advertisement may be displayed in the virtual space provided by the providing apparatus 20. This advertisement is displayed, for example, at a specific position in the virtual space. However, the advertisement may be moving. For example, the advertisement may be a non-player character. The advertisement may be generated using generative artificial intelligence (AI).

In a case where an advertisement is included in an image displayed on the display 310, there is a possibility that a load on the communication apparatus 30 increases due to the advertisement. If this load is too large, there is a possibility that the communication apparatus cannot perform appropriate processing. Therefore, the advertisement information processing apparatus 10 evaluates the advertisement based on the load and generates appropriateness information indicating appropriateness of displaying the advertisement in the virtual space.

The load of the communication apparatus 30 is evaluated by, for example, the peak value of the calculation amount per unit time performed by the communication apparatus 30, but may be evaluated by another index, for example, the usage rate of an arithmetic processing apparatus such as a CPU or a GPU or the frame rate of an image.

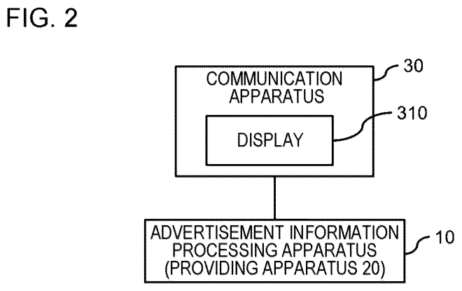

As illustrated in FIG. 2, the advertisement information processing apparatus 10 may also serve as the providing apparatus 20.

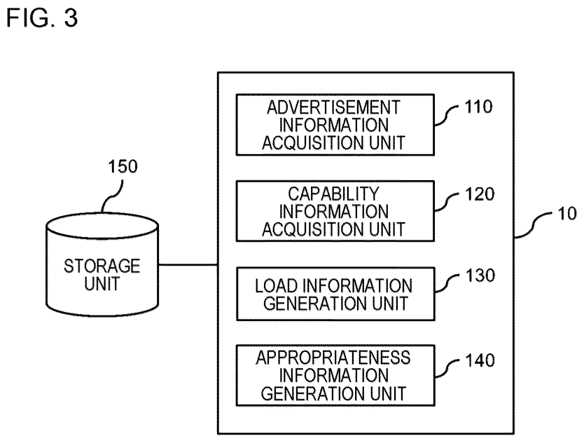

As illustrated in FIG. 3, for example, the advertisement information processing apparatus 10 includes an advertisement information acquisition unit 110, a capability information acquisition unit 120, a load information generation unit 130, and an appropriateness information generation unit 140, and can use information stored in the storage unit 150. The storage unit 150 may be a part of the advertisement information processing apparatus 10, may be a part of the providing apparatus 20, or may be an apparatus different from these.

The advertisement information acquisition unit 110 acquires target advertisement information. The target advertisement information is information for identifying the magnitude of the load generated in the communication apparatus that displays the image based on the virtual space on the display, and is information capable of identifying the magnitude of the load in a case where the target advertisement is included in the image described above. The advertisement information acquisition unit 110 acquires target advertisement information from the storage unit 150, for example.

The capability information acquisition unit 120 acquires necessary capability information. The necessary capability information is information regarding the virtual space and indicates a capability required for the communication apparatus 30. It can also be said that the necessary capability information indicates the minimum value of the capability of the communication apparatus 30 used by the user in the virtual space. The capability information acquisition unit 120 acquires necessary capability information from the storage unit 150, for example.

The load information generation unit 130 generates the load information using the target advertisement information. The load information indicates the magnitude of the load in a case where the target advertisement is included in the image.

The appropriateness information generation unit 140 generates the appropriateness information using the load information and the necessary capability information. The appropriateness information indicates appropriateness of displaying the target advertisement in the virtual space. For example, in a case where it is indicated that the load indicated by the load information is too large for the capability indicated by the necessary capability information, the appropriateness information indicates that it is inappropriate to display the target advertisement in the virtual space. On the other hand, in other cases, the appropriateness information indicates that no problem occurs even if the target advertisement is displayed in the virtual space.

As described above, the advertisement information processing apparatus 10 generates the appropriateness information using the target advertisement information and the necessary capability information. Therefore, using the advertisement information processing apparatus 10, for example, the administrator of the providing apparatus 20 can easily evaluate whether it is appropriate to display the target advertisement in the virtual space from the viewpoint of the load applied to the communication apparatus 30.

Hereinafter, the advertisement information processing apparatus 10 will be described in detail.

The advertisement information acquisition unit 110 acquires target advertisement information. The target advertisement information is information for identifying the magnitude of the load on the communication apparatus 30 in a case where the target advertisement is included in the image to be displayed on the display 310. The target advertisement information includes, for example, at least one of the following:
At least part of code indicating target advertisement
Information indicating whether target advertisement is moving image
Information indicating whether shape of target advertisement is two-dimensional or three-dimensional
Whether target advertisement is provided by non-player character (hereinafter, described as NPC)

The case where the target advertisement is provided by the NPC indicates that the NPC provides information regarding a product or service to be advertised. The method for providing the information is, for example, at least one of outputting the information by the NPC speaking, outputting an image or a video as an advertisement in the vicinity of the NPC, and indicating the information by the operation of the NPC. The target advertisement information includes information capable of identifying at least one of statement by the NPC, an image or video output as an advertisement in the vicinity of the NPC, and an operation of the NPC. This information is included in, for example, a code indicating the target advertisement.

The capability information acquisition unit 120 acquires necessary capability information. The necessary capability information is information regarding the virtual space and indicates a capability required for the communication apparatus 30. The capability here is, for example, at least one of information indicating a hardware specification of the communication apparatus 30 and a type of the communication apparatus 30.

The information indicating the specification is, for example, at least one of the following.
At least one of type and capability of central processing unit (CPU)
Memory capacity
At least one of type and capability of graphics processing unit (GPU)
At least one of graphic board type and capability

The type of the communication apparatus 30 is, for example, any of a smartphone, virtual reality (VR) goggles, augmented reality (AR) glasses, a tablet terminal, a desktop notebook personal computer, or a notebook personal computer.

The capability information acquisition unit 120 is defined as, for example, a reference regarding capability necessary for displaying an image based on the virtual space on the display 310. This reference is set as, for example, a reference for logging in to the virtual space, and is stored in the storage unit 150. In a case where the providing apparatus 20 can provide a plurality of virtual spaces, the necessary capability information may be information capable of identifying the capability required for the communication apparatus 30 for each of the plurality of virtual spaces. Also in a case where the advertisement information processing apparatus 10 is associated to a plurality of providing apparatuses 20, and the plurality of providing apparatuses 20 provide mutually different virtual spaces, the necessary capability information may be information capable of identifying the capability required for the communication apparatus 30 for each of the plurality of virtual spaces. For example, the necessary capability information may indicate the above-described reference for each of the plurality of virtual spaces.

The load information generation unit 130 generates the load information using the target advertisement information. The load information indicates the magnitude of the load in a case where the target advertisement is included in the image.

For example, the load information generation unit 130 generates a numerical value indicating the magnitude of the load using at least a part of the code indicating the target advertisement. For example, the load information generation unit 130 executes processing for displaying the target advertisement using this code, and sets a numerical value indicating the magnitude of the load generated in this execution as the load information.

In a case where the target advertisement is a moving image, the load information generation unit 130 increases the load indicated by the load information more than in a case where the target advertisement is a still image. The load information generation unit 130 increases the load indicated by the load information in a case where the shape of the target advertisement is three-dimensional than in a case where the shape of the target advertisement is two-dimensional.

In a case where the target advertisement is provided by the NPC, the load information generation unit 130 increases the load indicated by the load information as compared with other cases.

The appropriateness information generation unit 140 generates the appropriateness information using the load information and the necessary capability information. The appropriateness information indicates appropriateness of displaying the target advertisement in the virtual space. For example, the appropriateness information generation unit 140 may generate the appropriateness information by processing the load information and the necessary capability information according to a predetermined rule. The appropriateness information generation unit 140 may generate the appropriateness information by inputting the load information and the necessary capability information to a model generated by machine learning and obtaining an output from the model.

As described above, in a case where it is indicated that the load indicated by the load information is too large for the capability indicated by the necessary capability information, the appropriateness information may indicate that it is inappropriate to display the target advertisement in the virtual space. On the other hand, in other cases, the appropriateness information may indicate that no problem occurs even if the target advertisement is displayed in the virtual space. The appropriateness information may indicate appropriateness of displaying the target advertisement in the virtual space in three or more stages.

The appropriateness information may include a score indicating appropriateness of displaying the target advertisement in the virtual space. In this case, for example, as the score increases, the possibility that a problem occurs in a case where the target advertisement is displayed in the virtual space decreases.

In a case where there are a plurality of virtual spaces associated to the advertisement information processing apparatus 10, as described above, the necessary capability information may be capable of identifying the capability required for the communication apparatus 30 for each of the plurality of virtual spaces. In this case, the appropriateness information generation unit 140 generates the appropriateness information for each of the plurality of virtual spaces. For example, the appropriateness information generation unit 140 identifies the capability required for the communication apparatus 30 for each virtual space using the necessary capability information. Then, the appropriateness information generation unit 140 generates the appropriateness information for each of the plurality of virtual spaces using the load information and the capability identified for each virtual space. Here, the load information may be used as information common to a plurality of virtual spaces.

The advertisement information acquisition unit 110 may further acquire condition information indicating a condition related to a display mode of the target advertisement in a case where the target advertisement is included in the image. In this case, the appropriateness information generation unit 140 generates the appropriateness information by further using the condition information.

The condition information includes, for example, at least one of the following:
In case where advertisement includes character, at least one of resolution and frame rate for displaying character as image
Type of color used in a case where advertisement is displayed as image. For example, at least one of whether monochrome is acceptable or not, and type and number of colors that should be used at minimum in case of color display
In case where advertisement includes character, matters permitted for statement, action, and pose of character
In case where advertisement includes character, matters prohibited for statement, action, and pose of character

Then, the appropriateness information generation unit 140 performs, for example, the following processing. First, the appropriateness information generation unit 140 determines whether the target advertisement satisfies the condition information using the code included in the target advertisement information. For example, the appropriateness information generation unit 140 displays the target advertisement in the virtual space, and determines whether the display result satisfies the condition information. Then, in a case where the target advertisement does not satisfy the condition information, the appropriateness information generation unit 140 includes information indicating that the target advertisement does not satisfy the condition information in the appropriateness information. In this case, the appropriateness information includes information indicating whether the target advertisement satisfies the condition information and information based on a load generated in the communication apparatus 30.

The condition information may be indicated by, for example, a use definition document in using the character. In this case, for example, the appropriateness information generation unit 140 may input sentences included in the use definition document and the image indicating the target advertisement to a large language model (LLM), and determine whether the target advertisement satisfies the condition information using the information output from the large language model. The image input to the large language model may be a plurality of frame images constituting a moving image.

The appropriateness information generation unit 140 may generate the appropriateness information using only the condition information. In this case, the appropriateness information includes information indicating whether the target advertisement satisfies the condition information, but does not include information based on a load generated in the communication apparatus 30.

The advertisement information acquisition unit 110 may further acquire target information indicating an attribute of a person assumed as a target of the target advertisement. The target advertisement is included in the image displayed on the display 310 only in a case where the attribute of the user operating the communication apparatus 30 satisfies the target information. In this case, the appropriateness information generation unit 140 generates the appropriateness information by further using the target information. The attribute indicated by the target information is, for example, at least one of age, gender, and hobby.

The specifications of the communication apparatus 30 have a certain tendency depending on attributes of a person who uses the communication apparatus 30. For example, the specifications of the communication apparatus 30 used by young people tend to be high. The specifications of the communication apparatus 30 used by a person who likes games tend to be high. The specifications of the communication apparatus 30 used by men tend to be high. Therefore, the appropriateness information generation unit 140 may change a part of the processing for generating the appropriateness information, for example, using the attribute indicated by the target information, and may substantially change the criterion as to whether it is appropriate to display the target advertisement in the virtual space.

For example, in a case where the target advertisement is directed to a person of a predetermined age group, and this age group is included in a predetermined range, the appropriateness information generation unit 140 may multiply the capability indicated by the necessary capability information by a coefficient larger than 1, or may multiply the load information by a coefficient less than 1. Here, the predetermined range is, for example, 20 years old or more and 40 years old or less, but is not limited thereto. In a case where the appropriateness information includes a score, that is, in a case where whether it is appropriate to display the target advertisement in the virtual space is indicated by the score, the appropriateness information generation unit 140 may multiply the score by a coefficient larger than 1 instead of multiplying the necessary capability information and the load information by the coefficient.

In a case where the target advertisement is directed to a person who likes games, the appropriateness information generation unit 140 may multiply the capability indicated by the necessary capability information by a coefficient larger than 1 or may multiply the load information by a coefficient less than 1. In a case where the appropriateness information includes a score, the appropriateness information generation unit 140 may multiply the score by a coefficient larger than 1 instead of multiplying the necessary capability information and the load information by the coefficient.

In a case where the target advertisement is provided by the NPC, the target advertisement information preferably includes information capable of identifying at least one of the operation and the statement of the NPC. An example of this information is at least a part of the code of the target advertisement. Hereinafter, this information is referred to as operation information. In this case, the appropriateness information generation unit 140 preferably generates the appropriateness information by further using the operation information.

For example, in a case where at least one of the operation and the statement of the NPC includes a matter defined in advance as a prohibited matter, the appropriateness information generation unit 140 includes warning information indicating the fact in the appropriateness information. The information indicating the prohibited matters is stored in the storage unit 150, for example. Then, the appropriateness information generation unit 140 acquires this information from the storage unit 150.

The information indicated by the prohibited matters indicates, for example, at least one of the following.
Specific pose
Specific motion
Specific word

Then, the appropriateness information generation unit 140 actually operates, for example, the NPC, and determines whether prohibited matters are included in the image and voice indicating this operation. Then, the appropriateness information generation unit 140 generates warning information in a case where prohibited matters are included. The image used here may be either a video image or a still image. The appropriateness information generation unit 140 may generate a plurality of images in which the NPC is viewed from different directions, and perform the above-described determination on each of the plurality of images. Then, the appropriateness information generation unit 140 generates warning information in a case where a prohibited matter is included in at least one image.

The above-mentioned prohibited matters may be determined for each region. In this case, the storage unit 150 stores information indicating the prohibited matters for each region. Then, the appropriateness information generation unit 140 may generate warning information for each region. Here, one region may be one country, or may be a set of a plurality of countries such as North America, South America, and Europe.

In a case where there are a plurality of virtual spaces associated to the advertisement information processing apparatus 10, the above-described prohibited matters may be determined for each virtual space. In this case, the storage unit 150 stores information indicating the prohibited matter for each virtual space. Then, the appropriateness information generation unit 140 may generate warning information for each virtual space. For example, such a configuration may be adopted in a case where the virtual space is associated to a specific culture or country.

The appropriateness information generation unit 140 may generate the appropriateness information using only the information indicating the prohibited matters. In this case, the appropriateness information includes information indicating whether the operation or the like of the NPC included in the target advertisement includes the prohibited matters, but does not include information based on the load generated in the communication apparatus 30.

The appropriateness information generation unit 140 may confirm whether the target advertisement includes content that the user feels uncomfortable with, and generate information indicating a confirmation result. Whether the user feels uncomfortable is identified by, for example, words and sentences included in the advertisement and a movement of the character included in the advertisement. The appropriateness information generation unit 140 may generate the information indicating the confirmation result described above using, for example, a model generated by machine learning. In this case, the model is generated, for example, by learning advertisement information of an advertisement including content that the user feels uncomfortable with and information indicating a cause of the user's discomfort. Then, the appropriateness information generation unit 140 inputs the advertisement information of the target advertisement to this model and acquires an output from this model. Then, the appropriateness information generation unit 140 sets the output as at least a part of the information indicating the confirmation result.

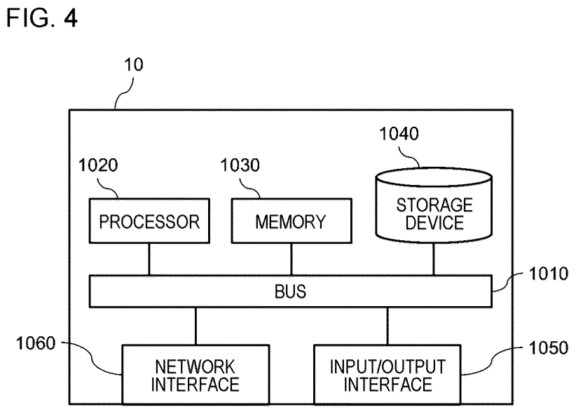

As illustrated in FIG. 4, for example, the advertisement information processing apparatus 10 includes a bus 1010, a processor 1020, a memory 1030, a storage device 1040, an input/output interface 1050, and a network interface 1060 as a hardware configuration.

The bus 1010 is a data transmission path for the processor 1020, the memory 1030, the storage device 1040, the input/output interface 1050, and the network interface 1060 to transmit and receive data to and from each other. However, the method for connecting the processor 1020 and other components to each other is not limited to the bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus implemented by a removable medium such as a hard disk drive (HDD), a solid state drive (SSD), a memory card, or a flash read only memory (FROM), and has a recording medium. The recording medium of the storage device 1040 stores a program module that implements each function (for example, the advertisement information acquisition unit 110, the capability information acquisition unit 120, the load information generation unit 130, and the appropriateness information generation unit 140) of the advertisement information processing apparatus 10. The processor 1020 implements the functions associated to the program modules by reading and executing the program modules on the memory 1030. The storage device 1040 may further function as the storage unit 150.

The input/output interface 1050 is an interface for connecting the advertisement information processing apparatus 10 and various pieces of input/output equipment. For example, the advertisement information processing apparatus 10 may communicate with the storage unit 150 via the input/output interface 1050.

The network interface 1060 is an interface for connecting the advertisement information processing apparatus 10 to a network. The network is, for example, a local area network (LAN) or a wide area network (WAN). A method for connecting the network interface 1060 to the network may be a wireless connection or a wired connection. The advertisement information processing apparatus 10 may communicate with the providing apparatus 20, the communication apparatus 30, and the storage unit 150 via the network interface 1060.

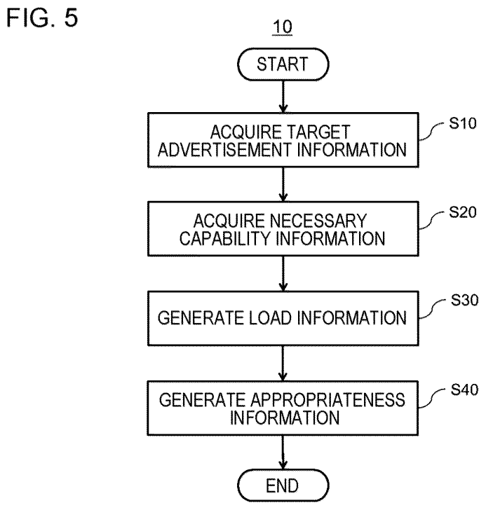

The advertisement information processing apparatus 10 performs processing according to the flowchart illustrated in FIG. 5, for example. This processing may be performed, for example, every time a new advertisement is provided in the virtual space, or may be performed in a batch format.

First, the advertisement information acquisition unit 110 identifies a target advertisement and acquires target advertisement information of the target advertisement (step S10). The capability information acquisition unit 120 acquires necessary capability information (step S20). Next, the load information generation unit 130 generates the load information using the target advertisement information (step S30). Then, the appropriateness information generation unit 140 generates the appropriateness information using the load information and the necessary capability information (step S40).

The appropriateness information generation unit 140 stores the appropriateness information in the storage unit 150 in association with, for example, the target advertisement. Then, the administrator of the virtual space refers to the appropriateness information and determines whether the target advertisement may be displayed in the virtual space.

As described above, in a case where the advertisement information processing apparatus 10 is used, the administrator of the virtual space can easily evaluate whether it is appropriate to display the target advertisement in the virtual space from the viewpoint of the load applied to the communication apparatus 30.

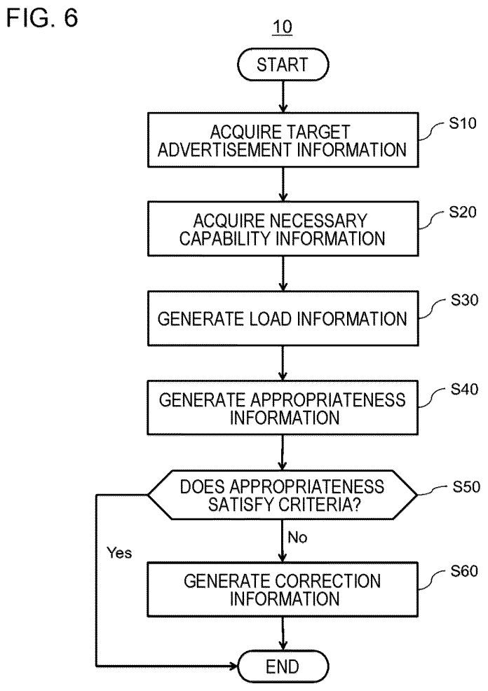

The advertisement information processing apparatus 10 may operate to output the correction information as illustrated in FIG. 6.

In this example, after the appropriateness information generation unit 140 generates the appropriateness information (step S40), in a case where the appropriateness does not satisfy the criteria (step S50: No), the appropriateness information generation unit 140 generates correction information that is information for prompting correction of the target advertisement (step S60). The appropriateness information generation unit 140 stores the correction information in the storage unit 150 in association with, for example, the target advertisement. Then, the administrator of the virtual space provides the correction information to the advertiser. In this way, the advertiser can recognize that the target advertisement needs to be corrected.

The correction information may include, for example, a text indicating that the target advertisement needs to be corrected, and may further include information indicating contents to be corrected in the target advertisement. This information is, for example, at least one of lowering the resolution of the target advertisement, lowering the frame rate of the moving image included in the target advertisement, and reducing the types of colors used in a case where the advertisement is displayed as an image, but is not limited thereto.

The appropriateness information generation unit 140 may generate the correction information using a model generated by machine learning. In this example, the model is generated by learning information (for example, an image of an advertisement before and after correction) capable of identifying a correction content in a case where the advertisement is corrected in order to reduce a load on the communication apparatus 30, for example. As an example, this model outputs, as at least a part of the correction information, reducing the number and movement of the hair of the character to be included in the advertisement.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the plurality of flowcharts used in the above description, a plurality of steps (pieces of processing) is described in order, but the execution order of the steps executed in each example embodiment is not limited to the described order. In each example embodiment, the order of the illustrated steps can be changed as long as nothing interferes in terms of content.

Some or all of the example embodiments described above may be described as the following Supplementary Notes, but are not limited to the following.
1. An advertisement information processing apparatus including:
an advertisement information acquisition means for acquiring target advertisement information that is information for identifying a magnitude of a load generated in a communication apparatus that causes a display to display an image based on a virtual space, the target advertisement information being capable of identifying the magnitude of the load in a case where a target advertisement is included in the image;
a capability information acquisition means for acquiring necessary capability information that is information regarding the virtual space and indicates capability required for the communication apparatus;
a load information generation means for generating load information indicating the magnitude of the load in a case where the target advertisement is included in the image by using the target advertisement information; and
an appropriateness information generation means for generating appropriateness information indicating appropriateness of displaying the target advertisement in the virtual space by using the load information and the necessary capability information.
2. The advertisement information processing apparatus according to the above 1, wherein
the virtual space includes a plurality of virtual spaces,
the necessary capability information is capable of identifying the capability for each of the plurality of virtual spaces, and
the appropriateness information generation means generates the appropriateness information for each of the plurality of virtual spaces.
3. The advertisement information processing apparatus according to the above 1 or 2, wherein
the advertisement information acquisition means further acquires condition information indicating a condition related to a display mode of the target advertisement in a case where the target advertisement is included in the image, and
the appropriateness information generation means generates the appropriateness information by further using the condition information.
4. The advertisement information processing apparatus according to any one of the above 1 to 3, wherein
the advertisement information acquisition means further acquires target information indicating an attribute of a person assumed as a target of the target advertisement,
the target advertisement is displayed on the display in a case where an attribute of a user operating the communication apparatus satisfies the target information, and
the appropriateness information generation means generates the appropriateness information by further using the target information.
5. The advertisement information processing apparatus according to any one of the above 1 to 4, wherein
the appropriateness information generation means generates correction information that is information for prompting correction of the target advertisement in a case where the appropriateness does not satisfy a criterion.
6. The advertisement information processing apparatus according to the above 5, wherein
the correction information includes information indicating content to be corrected in the target advertisement.
7. The advertisement information processing apparatus according to any one of the above 1 to 6, wherein
the target advertisement is provided by a non-player character,
the target advertisement information includes operation information capable of identifying at least one of an operation and a statement of the non-player character, and
the appropriateness information generation means generates the appropriateness information by further using the operation information.
8. The advertisement information processing apparatus according to the above 7, wherein
the appropriateness information generation means further includes, in the appropriateness information, warning information indicating that at least one of the operation and the statement of the non-player character includes a matter defined in advance as a prohibited matter.
9. The advertisement information processing apparatus according to the above 8, wherein
the prohibited matter is determined for each region, and
the appropriateness information generation means generates the warning information for each region.
10. The advertisement information processing apparatus according to the above 8 or 9, wherein
the virtual space includes a plurality of virtual spaces,
the prohibited matter is determined for each of the virtual spaces, and
the appropriateness information generation means generates the warning information for each of the virtual spaces.
11. The advertisement information processing apparatus according to any one of the above 8 to 10, wherein
the appropriateness information generation means generates a plurality of images in which the non-player character is viewed from different directions, and generates the warning information by using the plurality of images.
12. An advertisement information processing method including, by a computer:
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image;
acquiring necessary capability information that is information regarding the virtual space and indicates capability required for the communication apparatus;
generating load information indicating the magnitude of the load in a case where the target advertisement is included in the image by using the target advertisement information; and
generating appropriateness information indicating appropriateness of displaying the target advertisement in the virtual space by using the load information and the necessary capability information.
13. A program for causing
a computer to implement:
an advertisement information acquisition means for acquiring target advertisement information that is information for identifying a magnitude of a load generated in a communication apparatus that causes a display to display an image based on a virtual space, the target advertisement information being capable of identifying the magnitude of the load in a case where a target advertisement is included in the image;
a capability information acquisition means for acquiring necessary capability information that is information regarding the virtual space and indicates capability required for the communication apparatus;
a load information generation means for generating load information indicating the magnitude of the load in a case where the target advertisement is included in the image by using the target advertisement information; and
an appropriateness information generation means for generating appropriateness information indicating appropriateness of displaying the target advertisement in the virtual space by using the load information and the necessary capability information.
14. A recording medium on which the program according to above 13 is recorded.

Some or all of the configurations described in Supplementary Notes 2 to 11 dependent on the above-described Supplementary Note 1 can also be dependent on each of Supplementary Notes 12 to 14 by similar dependency relationship to Supplementary Notes 2 to 11. Not only Supplementary Notes 1 and 12 to 14, but also various hardware, software, various recording means for recording software, or systems can be similarly dependent on some or all of the configurations described as the supplementary notes without departing from the above-described example embodiments.

1. An advertisement information processing apparatus comprising:
at least one memory storing instructions; and
at least one processor configured to execute the instructions to perform operations comprising:
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image;
acquiring necessary capability information that is information regarding the virtual space and indicates capability required for the communication apparatus;
generating load information indicating the magnitude of the load in a case where the target advertisement is included in the image by using the target advertisement information; and
generating appropriateness information indicating appropriateness of displaying the target advertisement in the virtual space by using the load information and the necessary capability information.

2. The advertisement information processing apparatus according to claim 1, wherein
the virtual space includes a plurality of virtual spaces,
the necessary capability information is capable of identifying the capability for each of the plurality of virtual spaces, and
the operations comprise generating the appropriateness information for each of the plurality of virtual spaces.

3. The advertisement information processing apparatus according to claim 1, wherein the operations comprise:
acquiring condition information indicating a condition related to a display mode of the target advertisement in a case where the target advertisement is included in the image; and
generating the appropriateness information by further using the condition information.

4. The advertisement information processing apparatus according to claim 1, wherein the operations comprise:
acquiring target information indicating an attribute of a person assumed as a target of the target advertisement;
displaying the target advertisement on the display in a case where an attribute of a user operating the communication apparatus satisfies the target information; and
generating the appropriateness information by further using the target information.

5. The advertisement information processing apparatus according to claim 1, wherein
the operations comprise generating correction information that is information for prompting correction of the target advertisement in a case where the appropriateness does not satisfy a criterion.

6. The advertisement information processing apparatus according to claim 5, wherein
the correction information includes information indicating content to be corrected in the target advertisement.

7. The advertisement information processing apparatus according to claim 1, wherein
the target advertisement is provided by a non-player character,
the target advertisement information includes operation information capable of identifying at least one of an operation and a statement of the non-player character, and
the operations comprise generating the appropriateness information by further using the operation information.

8. The advertisement information processing apparatus according to claim 7, wherein
the operations comprise including, in the appropriateness information, warning information indicating that at least one of the operation and the statement of the non-player character includes a matter defined in advance as a prohibited matter.

9. The advertisement information processing apparatus according to claim 8, wherein the prohibited matter is determined for each region, and the operations comprise generating the warning information for each region.

10. The advertisement information processing apparatus according to claim 8, wherein
the virtual space includes a plurality of virtual spaces,
the prohibited matter is determined for each of the virtual spaces, and
the operations comprise generating the warning information for each of the virtual spaces.

11. The advertisement information processing apparatus according to claim 8, wherein the operations comprise:
generating a plurality of images in which the non-player character is viewed from different directions; and
generating the warning information by using the plurality of images.

12. An advertisement information processing method comprising, by a computer:
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image;
acquiring necessary capability information that is information regarding the virtual space and indicates capability required for the communication apparatus;
generating load information indicating the magnitude of the load in a case where the target advertisement is included in the image by using the target advertisement information; and
generating appropriateness information indicating appropriateness of displaying the target advertisement in the virtual space by using the load information and the necessary capability information.

13. The advertisement information processing method according to claim 12, wherein
the virtual space includes a plurality of virtual spaces,
the necessary capability information is capable of identifying the capability for each of the plurality of virtual spaces, and
the advertisement information processing method comprises generating the appropriateness information for each of the plurality of virtual spaces.

14. The advertisement information processing method according to claim 12, further comprising:
acquiring condition information indicating a condition related to a display mode of the target advertisement in a case where the target advertisement is included in the image; and
generating the appropriateness information by further using the condition information.

15. The advertisement information processing method according to claim 12, further comprising:
acquiring target information indicating an attribute of a person assumed as a target of the target advertisement;
displaying the target advertisement on the display in a case where an attribute of a user operating the communication apparatus satisfies the target information; and
generating the appropriateness information by further using the target information.

16. The advertisement information processing method according to claim 12, further comprising
generating correction information that is information for prompting correction of the target advertisement in a case where the appropriateness does not satisfy a criterion.

17. A non-transitory computer-readable medium storing a program for causing a computer to perform operations comprising:
acquiring target advertisement information that is information for identifying a magnitude of a load generated in a communication apparatus that causes a display to display an image based on a virtual space, the target advertisement information being capable of identifying the magnitude of the load in a case where a target advertisement is included in the image;
acquiring necessary capability information that is information regarding the virtual space and indicates capability required for the communication apparatus;
generating load information indicating the magnitude of the load in a case where the target advertisement is included in the image by using the target advertisement information; and
generating appropriateness information indicating appropriateness of displaying the target advertisement in the virtual space by using the load information and the necessary capability information.

18. The non-transitory computer-readable medium according to claim 17, wherein
the virtual space includes a plurality of virtual spaces,
the necessary capability information is capable of identifying the capability for each of the plurality of virtual spaces, and
the operations comprise generating the appropriateness information for each of the plurality of virtual spaces.

19. The non-transitory computer-readable medium according to claim 17, wherein the operations comprise:
acquiring condition information indicating a condition related to a display mode of the target advertisement in a case where the target advertisement is included in the image; and
generating the appropriateness information by further using the condition information.

20. The non-transitory computer-readable medium according to claim 17, wherein the operations comprise:
acquiring target information indicating an attribute of a person assumed as a target of the target advertisement;
displaying the target advertisement on the display in a case where an attribute of a user operating the communication apparatus satisfies the target information; and
generating the appropriateness information by further using the target information.
